(19) United States
(12) Patent Application Publication
(10) Pub. No.: US 2013/0218782 A1
(43) Pub. Date: Aug. 22, 2013

(54) EFFECTIVE UTILIZATION OF AN INTEGRATED SELF-CARE PORTAL FOR AN ENRICHED CUSTOMER EXPERIENCE

(71) Applicants: Manav Singal, Haryana (IN); Shivani Gupta, Punjab (IN); Mandeep Singh Sidhu, Punjab (IN)

(72) Inventors: Manav Singal, Haryana (IN); Shivani Gupta, Punjab (IN); Mandeep Singh Sidhu, Punjab (IN)

(73) Assignee: INFOSYS LIMITED, Bangalore (IN)

(21) Appl. No.: 13/532,232

(22) Filed: Jun. 25, 2012

(30) Foreign Application Priority Data
Feb. 17, 2012 (IN) 591/CHE/2012

(51) Int. Cl. G06Q 10/00

(52) U.S. Cl. 705/304

(57) ABSTRACT

This disclosure concerns an effective utilization of a self-care online portal containing enriched customer experience. Here the portal upon receiving a validated search string relevant to an issue faced and entered by the user through a web interface, displays the relevant information retrieved from the database by the server on the web interface thus enabling the user to resolve the issue by self-based on the retrieved relevant information. The user then gets rewarded for successful self-resolution of issue. Additionally, the user also gets an option of initiating one or more interaction channels comprising of but not restricted to a multimedia session or an audio conversation using a communicating device or a web enabled user discussion forums to further help in resolving the issue in a time effective optimized manner thereby creating an enriched customer experience.

This application claims the benefit of Indian Patent Application Filing No. 591/CHE/2012, filed Feb. 17, 2012, which is hereby incorporated by reference in its entirety.

### FIELD

The present disclosure relates to self-care portals, in particular, to effectively utilize the self-care portal to resolve customer issues related to a seamless integration between the portal, the knowledge management system and the agent contact center.

### BACKGROUND

It is standard practice for software suppliers or any online supplier to set up helpdesks to provide assistance to customers in order to resolve their problems with regards to the products sold. The help desk would then be instrumental in diagnosing the problem and in providing the solution to the customer. In the beginning, the first concepts of help desks involved getting connected with an agent using a telephone over a public network. The customer had to dial special toll-free numbers, wait for a long period of time till an agent was free and then explain verbally the issues. This process was time consuming and was limited with regards to data sharing which would help in explaining the problem in required detail in order to enable the agent to solve it at the earliest. It was highly dependent on the ability of the customer to be able to convey the depth of problem accurately to the agent thereby limiting the response and efficacy of the solution. As time progressed and technology advanced, with the advent of the internet, online sharing of data using multimedia sessions became the norm of the day making problem solving and diagnostics much more effective and simpler.

The current process involves online websites which provide FAQs (frequently answered questions) and generic troubleshooting advice enabling a customer to self-diagnose and solve the problem themselves; failing which they have the additional option of speaking directly with an agent through phone or multimedia sessions where varied forms of data can be shared with the agent to enable them to understand and solve the problem effectively. These two processes are still discrete and non-interactive in the sense that, they occur sequentially and take quite a bit of time.

A customer would first try self-diagnosing and then solving the problem based on online websites. Failing which, they would initiate a session with the agent directly either through a chat session or over a phone as a follow-up independent event. Here they would again have to repeat the entire process of explaining the problem and the data and wait for the agent to resolve the issue. Also in this case, it is not necessary that the customer gets an agent who is familiar or an expert with the problem in hand, leading to further time delay in problem resolution. All of this results in a huge wastage of time and resources from both sides with the problem not being effective and optimally solved. Due to the sequential nature of the problem solving at the customer's end taking double the time for online self-solving and then the agent, it reduces the incentive for the customer to self-solve making them directly contact the agent more frequently. This ends up putting a huge constraint on the resources, money and time that the software or online suppliers will have to expend for providing solutions.

### SUMMARY

Aspects of the disclosure relate to relates to self-care portals, in particular, to effectively utilize the self-care portal to resolve customer issues related to a seamless integration between the portal, the knowledge management system and the agent contact center.

One embodiment of the present disclosure refers to an effective online self-care portal for addressing the customer issues while providing an enriched experience. The method of the present embodiment involves the customer, who has an issue with product or solutions sold by the supplier, providing credentials to log into the supplier's online website. Additionally, the user may enter keywords describing the nature of the problem enabling the interactive knowledge management system to retrieve the relevant data in the form of audio, video or text format, to enable the user to diagnose and solve the problem by self in an effective manner utilizing least amount of time. In the event that this is not enough, then the system allows the user to initiate a conversation with an agent on the click of a button through online web interface utilizing three different venues. The different venues being a telephone, media chat session or through user discussion boards. An important aspect of this ‘click-to-initiate’ function with the agent is that all the relevant information entered and retrieved so far by the user with regards to the query, is transferred with context to the agent automatically saving huge amounts of time in being repetitive to explain the same to the agent. Additionally, the selection of the agent is done by the system in an intelligent time-saving manner based on certain parameters like skill and expertise, customer preference and type etc. This process enables and ensures the right agent is chosen to resolve the issue in the most optimum manner based on the requirements. Also, user experience is enriched and encouraged in this system by having a reward system for self-solving the issues and also contributing to solving other issues on the user discussion boards.

### DRAWINGS

These and other features, aspects, and advantages of the present invention will be better understood when the following detailed description is read with reference to the accompanying drawings in which like characters represent like parts throughout the drawings, wherein:

FIG. 1 is a block diagram illustrating a system 100 for effectively utilizing a self-care online portal with enriched customer experience, in accordance with an embodiment of the present disclosure;

FIG. 2 is a flow chart illustrating a method 200 for effectively utilizing a self-care online portal with enriched customer experience, in accordance with an embodiment of the present disclosure; and

FIG. 3 is a system illustrating a generalized computer network arrangement, in accordance with an embodiment of the present disclosure.

### DETAILED DESCRIPTION

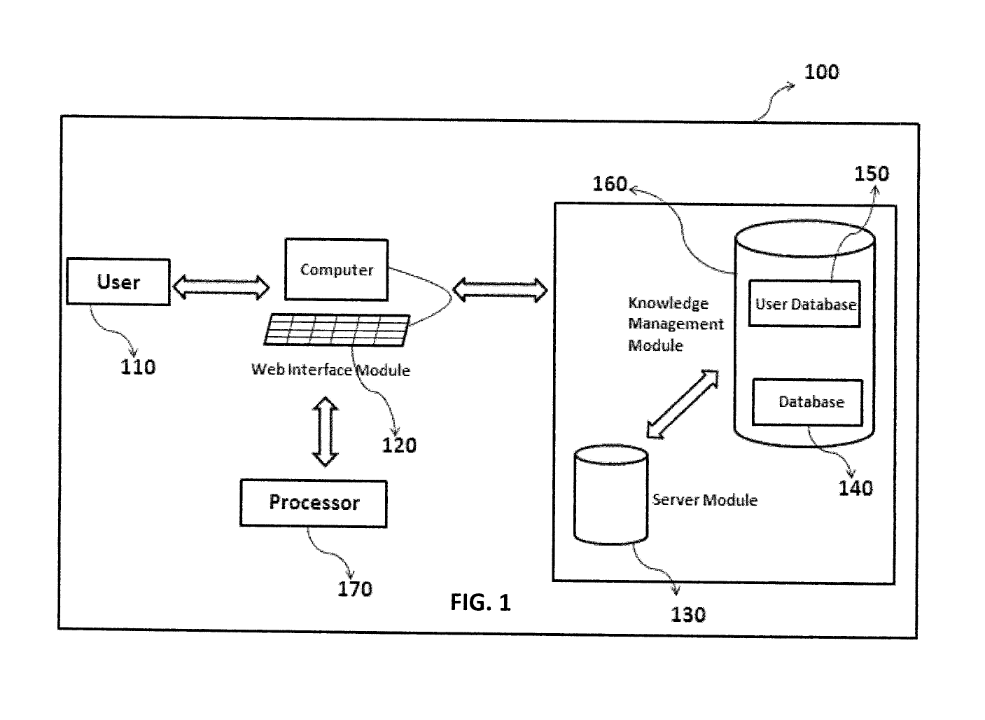

FIG. 1 is a flow chart illustrating a system 100 for effectively utilizing a self-care online portal with enriched customer experience, in accordance with an embodiment of the present disclosure.

The system 100 comprises a user 110, a web interface module 120, a processor coupled to the web interface module 170, a server module 130, a database 140, a user database 150 and a knowledge management module 160. The database 140 and the user database 150 may be comprised within the knowledge management module 160.

The user 110 may login to the server module 130 using credentials which may be verified by the server module 130 with the user database 150. After the verification of the user 110 credentials, the server module 130 may retrieve the user relevant information. The user 110 can set a particular preference of his or her choice.

The user 110 may enter a search string into the server module 130 through the web interface module 120. The search string may be validated internally to check for the consistency or the syntax of the search string. The search string may comprise but not restricted to alphabets, numbers or special characters. The information in the search string may be related to a problem faced by the user 110 in a particular area or domain.

The processor 170 in the web interface module 120 may retrieve information intelligently from the knowledge management module 160 using the information of the search string mapped onto the problem in the particular area or domain. The information related to the domain specific area would be retrieved from the database 140 comprised within the knowledge management module 160 and also the user database 150 for preferences pertaining to the user. The information retrieved could be in but not restricted to an audio file, a video file or a textual data with images.

The user 110 may use the retrieved information to solve a particular problem by referring to it. If the user 110 could successfully solve the problem by self, then the user 110 may be rewarded with certain points or recognition status.

In another embodiment of the present disclosure, if the user is not able to solve the problem by self after referring to the retrieved information, the user 110 may be provided with a means to initiate one or more interaction channels. These interaction channels may comprise but not restricted to a multimedia session through the web interface module 120, an audio session using a communication device through the web-interface module 120 and a web enabled user discussion forum using the web interface module 120.

The interaction channels provided to the user 110 may be configured to intelligently select and assign an appropriate agent to interact with the user 110 based on a number of parameters. These parameters may include the following but is not restricted to a user 110 preference, agent skill and a type of user 110. In continuation with this embodiment the context information such as search keywords, retrieved information about the user and retrieved information about the problem may be transferred to the agent through web-interface module 120. The data transferred to the agent may be in the form but not restricted to an audio file, a video file or an image. The agent may use the information which he or she receives to solve the problem or query in the most efficient and in the shortest time possible.

In another embodiment of the present disclosure the user 110 may initiate an audio interaction channel using a communication device to interact with the selected agent. The communication device may be but not restricted to a wireless mobile phone, a wired telephone, a voice over internet protocol. In this embodiment, the context information such as the search string, retrieved information by the server module 130 about the user and the problem may be transferred to the chosen agent through the web-interface module 120. The data then transferred to the agent may be in the form but not restricted to an audio file, a video file textual data or an image. The chosen agent may then use the information which he or she receives to solve the problem or query in the most efficient and in the shortest time possible.

In another embodiment of the present disclosure the server module 130 could be configured to connect the user 110 and the agent in the shortest time based on additional parameters such as agent availability. The context information such as the search string, retrieved information by the server module 130 about the user and the problem may be transferred to the chosen agent through the web-interface module 120. The data then transferred to the agent may be in the form but not restricted to an audio file, a video file textual data or an image. The chosen agent may then use the information which he or she receives to solve the problem or query in the most efficient and in the shortest time possible.

In another embodiment of the present disclosure, the user 110 may be connected to a web enabled user discussion forum on the server module 130 through the web interface module 120. The user 110 may be enabled to resolve the problem in a time effective manner using multiple forms of data and a plurality of peer input on the user discussion forum.

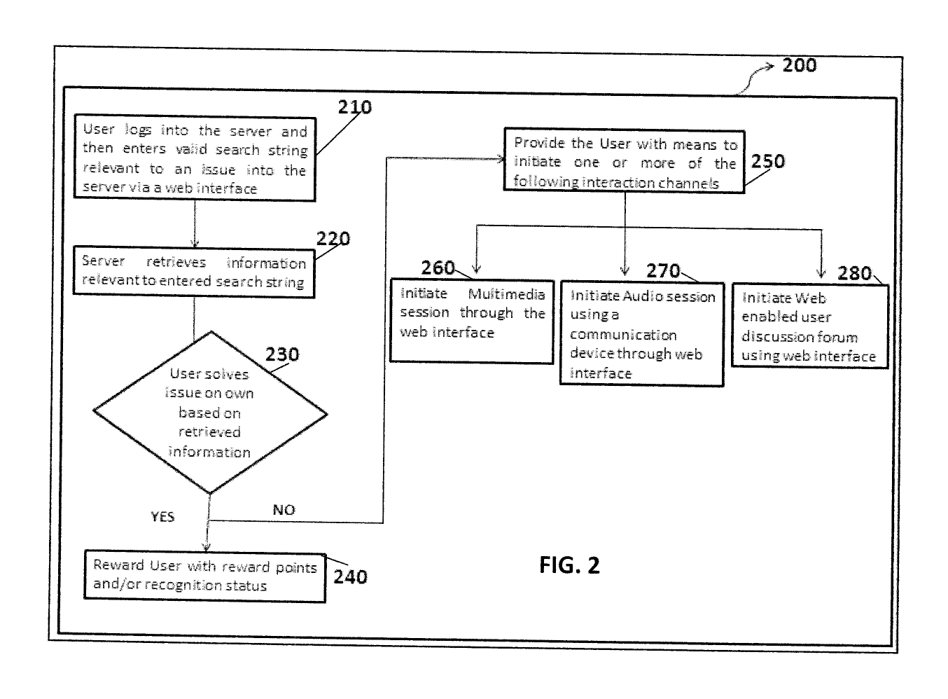

With reference to FIG. 2, method 200 includes a step 210 wherein a user first logs into the server and the user credentials are validated by the server against the user database. The user then enters a valid search string in the server through a web interface module in order to resolve an issue. At step 220 the server then retrieves relevant information from the database part of the knowledge management module based on the entered search string and the user preferences which are retrieved from the user database. At step 230 the user then attempts to solve the problem based on the retrieved relevant information which may be but not restricted to a combination of text, audio or video data form. Upon successfully solving the problem based on the retrieved relevant information, at step 240 the server then awards the user through the web interface with either or a combination of reward points and recognition status. In another embodiment of the disclosure, the user unable to solve the problem with the retrieved information from the server based on the entered search string is provided at step 250 with means to initiate one or more interaction channels. Initiation of interaction channels by user may comprise of but not restricted to initiating a multimedia session through the web interface module as mentioned in step 260, initiating an audio session using a communication device through the web-interface module as mentioned in step 270 and initiating a web enabled user discussion forum using the web interface module as mentioned in step 280.

The interaction channels provided to the user may be configured to intelligently select and assign an appropriate agent to interact with the user based on a number of parameters. These parameters may include the following but is not restricted to a user preference, agent skill and a type of user. In continuation with this embodiment the context information such as search keywords, retrieved information about the user and retrieved information about the problem may be transferred to the agent through web-interface module. The data transferred to the agent may be in the form but not restricted to an audio file, a video file or an image. The agent may use the information which he or she receives to solve the problem or query in the most efficient and in the shortest time possible.

At step 270, in another embodiment of the present disclosure the user may initiate an audio interaction channel using a communication device to interact with the selected agent. The communication device may be but not restricted to a wireless mobile phone, a wired telephone, a voice over internet protocol. In this embodiment, the context information such as the entered search string as in step 210, retrieved information by the server module about the user as in step 220 and the problem may be transferred to the chosen agent through the web-interface module. The data then transferred to the agent may be in the form but not restricted to an audio file, a video file textual data or an image. The chosen agent may then use the information which he or she receives to solve the problem or query in the most efficient and in the shortest time possible.

At step 280, in another embodiment of the present disclosure, the user may be connected to a web enabled user discussion forum on the server module through the web interface module. The user may be enabled to resolve the problem in a time effective manner using multiple forms of data and a plurality of peer input on the user discussion forum.

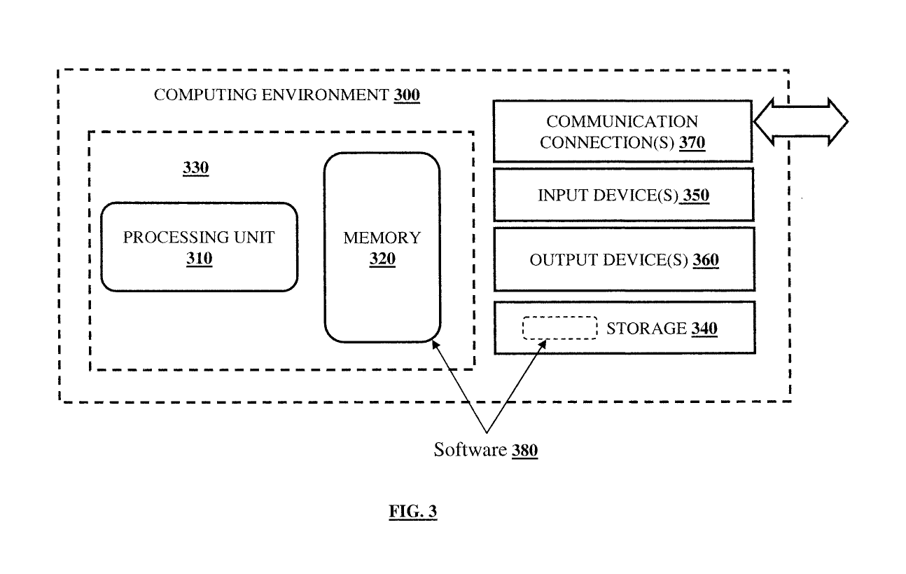

With reference to FIG. 3, the computing environment 300 includes at least one processing unit 310 and memory 320. In FIG. 3, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software 380 implementing described techniques.

A computing environment may have additional features. For example, the computing environment 300 includes storage 340, one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which may be used to store information and which may be accessed within the computing environment 300. In some embodiments, the storage 440 stores instructions for the software 380.

The input device(s) 350 may be a touch input device such as a keyboard, mouse, pen, trackball, touch screen, or game controller, a voice input device, a scanning device, a digital camera, or another device that provides input to the computing environment 300. The output device(s) 360 may be a display, a television, a hand held device, a head mounted display or a Kiosk that provides output from the computing environment 300.

The communication connection(s) 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 300, computer-readable media include memory 320, storage 340, communication media, and combinations of any of the above.

The sequence of instructions as explained in the above method steps may include a program code adapted for accepting at the minimum one validated search string relevant to an issue faced by a user, wherein the validated search string is entered by the user on a server through a web interface. The instructions may further include the program code adapted for displaying relevant information retrieved from a database by the server on the web interface based on the validated search string. The instructions may also further include the program code adapted for enabling the user to resolve the issue by self based on the relevant information retrieved upon which the user is rewarded. The instructions may also further include the program code adapted for providing the user one or more interaction channels comprising of initiating a multimedia session on the server through the web interface or initiating an audio conversation on the server through the web interface by a communicating device or connecting the user to an web enabled user discussion forum on the server through the web interface.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method of effectively utilizing a self-care online portal with an enriched customer experience, the method comprising:
accepting at least one valid search string relevant to an issue faced by a user, wherein the at least one valid search string is entered by the user on a server through a web interface;
displaying a relevant information retrieved from a database by the server on a web interface based on the at least one valid search string;
enabling the user to resolve the issue by self, based on the relevant information retrieved, the step further comprising rewarding the user upon successfully resolving the issue; and
providing the user one or more interaction channels comprising of:
initiating a multimedia session on the server through the web interface;
initiating an audio conversation on the server through the web interface by a communicating device; and
connecting the user to an web enabled user discussion forum on the server through the web interface.

2. The method of claim 1 further enabling the user to resolve the issue by user based on the relevant information retrieved from an interactive knowledge management system based on a decision tree approach.

3. The method of claim 1 wherein the interactive knowledge management system provides the user with relevant information sequentially in steps based on user inputs at each step.

4. The method of claim 1 further comprising authenticating the user wherein the user enters requisite credentials on the server through the web interface.

5. The method of claim 1 further comprising displaying a data specific to the user on the web interface retrieved from a user database.

6. The method of claim 1 wherein the relevant information is a plurality of text data, a plurality of audio data, or a plurality of video data.

7. The method of claim 1 wherein rewarding the user further comprises a plurality of reward points, or a plurality of recognition status.

8. The method of claim 1 wherein rewarding the user occurs upon the user solving the problem through the interactive knowledge management system or by using the web-enabled user discussion forum.

9. The method of claim 1 wherein initiating the multimedia session on the server through the web interface further comprises configuring the server to select an appropriate agent to interact with the customer through the multimedia session on the web interface based on specific parameters.

10. The method of claim 6 wherein the specific parameters retrieved from the user database is a user preference, an agent skill, or a customer type.

11. The method of claim 1 wherein initiating the multimedia session on the server through the web interface further comprises configuring the server to transfer an entire context of data to the agent through the web interface.

12. The method of claim 8 wherein the entire context of data comprises of the at least one valid search string, the relevant information retrieved by the server based on the at least one valid search string.

13. The method of claim 1 wherein initiating the multimedia session on the server through the web interface further comprises enabling the agent to resolve the issue in an effective time optimized manner using a multiple forms of data on the server through the web interface.

14. The method of claim 10 wherein the multiple forms of data is a plurality of text data, a plurality of audio data, or a plurality of video data.

15. The method of claim 1 wherein initiating the audio conversation on the server through the web interface by the communicating device further comprises configuring the server to transfer the entire context of data to the agent through the web interface.

16. The method of claim 12 wherein the communicating device is a wired telephonic instrument, or a wireless telephonic instrument.

17. The method of claim 12 further comprises of configuring the server to connect the audio conversation between the user and the agent in the shortest time based on the agent availability.

18. The method of claim 12 further comprises of enabling the agent to resolve the issue in the effective time optimized manner using the multiple forms of data on the server through the web interface.

19. The method of claim 1 wherein connecting the user to the web enabled user discussion forum on the server through the web interface further comprises enabling the user to resolve the issue in an effective time optimized manner using the multiple forms of data and a plurality of peer input on the user discussion forum through the web interface.

20. A system for effectively utilizing a self-care online portal with an enriched customer experience, they system comprising:
a web interface module configured to accept at least one valid search string relevant to an issue faced by a user;
a server module configured to accept at least one valid input from the web interface module, the server module further configured to authenticating the user; and
an interactive knowledge management module communicably coupled to the server module, the interactive knowledge management module further configured to transfer a multiple forms of data to the server module using decision based tree approach to enable the user to resolve the issue.

21. The system of claim 20 wherein the interactive knowledge management module comprises:
a database; and
a user database.

22. The system of claim 20 wherein the multiple forms of data is a plurality of text data, a plurality of audio data, or a plurality of video data.

23. The system of claim 20 wherein the web interface module is further configured to display the relevant information retrieved from the database by the server module based on the at least one valid search string.

24. The system of claim 20 wherein the web interface module is further configured to display the relevant information retrieved from the interactive knowledge management module sequentially in steps based on user input at each step.

25. The system of claim 23 wherein the relevant information is a plurality of text data, a plurality of audio data, or a plurality of video data.

26. The system of claim 20 wherein the web interface module is further configured to display a data specific to the user retrieved from the user database by the server module.

27. The system of claim 20 wherein the server module authenticates the user upon the user entering requisite credentials on the server module through the web interface.

28. The system of claim 20 wherein the web interface module is further configured to initiate on the server a multimedia session, an audio conversation, or a user discussion forum on the server module.

29. The system of claim 20 wherein the web interface module is further configured to display the multiple forms of data stored on the server.

30. The system of claim 20 wherein the server module is further configured to initiate the multimedia session through the web interface module, further comprises selecting an appropriate agent to interact with the customer through the multimedia session based on specific parameters.

31. The system of claim 20 wherein the server module is further configured to initiate the audio conversation through the web interface module by a communicating device, further comprises transferring the entire context of data to the agent.

32. The system of claim 31 wherein the communicating device is a wired telephonic instrument, or a wireless telephonic instrument.

33. The system of claim 30 wherein the specific parameters retrieved from the user database is a user preference, an agent skill, or a customer type.

34. The system of claim 31 wherein the entire context of data comprises of the at least one valid search string, the relevant information retrieved by the server based on the at least one valid search string.

35. The system of claim 20 wherein the server module is further configured to reward the user with a plurality of reward points, or a plurality of recognition status.

36. The system of claim 20 wherein the server module is further configured to rewarding the user upon the user solving the problem through the interactive knowledge management module or by using the web-enabled user discussion forum.

37. The system of claim 31 further comprises of configuring the server to connect the audio conversation between the user and the agent in the shortest time based on the agent availability.

38. The system of claim 30 further comprises of configuring the server module to enable the agent to resolve the issue in the effective time optimized manner using the multiple forms of data through the web interface module.

39. The system of claim 28 further comprises of configuring the server module to connect the user to the web enabled user discussion forum.

40. The system of claim 28 further comprises of configuring the server to enable the user to resolve the issue in an effective time optimized manner using the multiple forms of data and a plurality of peer input on the user discussion forum.

41. A computer program product, comprising a machine-accessible medium having instructions encoded thereon for enabling a processor to perform the operations of:
accepting at least one valid search string relevant to an issue faced by a user, wherein the at least one valid search string is entered by the user on a server through a web interface;
displaying a relevant information retrieved from a database by the server on a web interface based on the at least one valid search string;
enabling the user to resolve the issue by self based on the relevant information retrieved, the step further comprising rewarding the user upon successfully resolving the issue; and
providing the user one or more interaction channels comprising of:
initiating a multimedia session on the server through the web interface;
initiating an audio conversation on the server through the web interface by a communicating device; and
connecting the user to an web enabled user discussion forum on the server through the web interface.
